(19) United States
(12) Patent Application Publication
(10) Pub. No.: US 2010/0225947 A1
(43) Pub. Date: Sep. 9, 2010

(54) IMAGE FORMING SYSTEM, IMAGE FORMING APPARATUS AND IMAGE FORMING METHOD

(75) Inventors: Hiroki Yoshida, Takatsuki-shi (JP); Chiho Murai, Yao-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/715,763

(22) Filed: Mar. 2, 2010

(30) Foreign Application Priority Data
Mar. 4, 2009 (JP) 2009-051397

(51) Int. Cl. G06F 3/12; G08B 21/18

(52) U.S. Cl. 358/1.13; 340/540; 358/1.14

(57) ABSTRACT

The image forming system includes an image forming apparatus; a detection apparatus that detects a user who enters or exits a room where the image forming apparatus exists; and an administration server that judges a security level of the room based on a detection result drawn by the detection apparatus. The image forming apparatus selects a print mode based on the security level judged by the administration server and performs printing by the selected print mode.

This application claims priority under 35 U.S.C. §119 to Japanese Patent Application No. 2009-051397 filed on Mar. 4, 2009, the entire disclosure of which is incorporated herein by reference in its entirety.

### BACKGROUND OF THE INVENTION

1. Field of the Invention

The present invention relates to an image forming system including an image forming apparatus, a detection apparatus that detects users who enter or exit a room where the image forming apparatus exists, an administration server that judges a security level of the room based on a detection result drawn by the detection apparatus; an image forming apparatus preferably employed in this image forming system; and an image forming method implemented by this image forming system.

2. Description of the Related Art

The following description sets forth the inventor's knowledge of related art and problems therein and should not be construed as an admission of knowledge in the prior art.

Sometimes, when a person who is considered to be unfavorable for security reasons is in a room where an image forming apparatus exists, there is a need for prohibiting or permitting printing under strict control, to prevent the risk that a confidential document may be leaked to a third party.

In such a case, conventionally, users who try to print a confidential document had to give up printing on his/her voluntary judgment or had to keep within the vicinity of the image forming apparatus until completion of printing. This has been troublesome.

As described in Japanese Unexamined Laid-open Patent Publication No. 2007-241550, there is an image processing apparatus that obtains a set of authority information of a user who is permitted to enter a room of a predetermined security level, identification information of a printer and identification information that is the number of the room, and permits printing if this set of three information pieces matches any of those set in advance.

Meanwhile, as described in Japanese Unexamined Laid-open Patent Publication No. 2008-040956, there is a technology to start a user's printing when his/her print request is accepted, and also lock the room to prevent entry of other users.

However, using Japanese Unexamined Laid-open Patent Publication No. 2007-241550, even a user who is considered to be safe always has to obtain a set of authority information, identification information of a printer and identification information that is a room number. This has been still troublesome.

Furthermore, using Japanese Unexamined Laid-open Patent Publication No. 2008-040956, other users cannot enter the room. This has been inconvenient.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The Preferred embodiments of the present invention can significantly improve upon existing methods and/or apparatuses.

It is an object of the present invention to provide an image forming system that is capable of allowing a user's printing and ensuring security by an easy method, without limiting other users' entering or leaving a room.

It is another object of the present invention to provide an image forming apparatus preferably employed in this image forming system.

It is yet another object of the present invention to provide an image forming method implemented by this image forming system.

According to a first aspect of the present invention, an image forming system includes:
an image forming apparatus;
a detection apparatus that detects a user who enters or exits a room where the image forming apparatus exists; and
an administration server that judges a security level of the room based on a detection result drawn by the detection apparatus,
   and wherein:
the image forming apparatus comprises:
a print mode switcher that selects a print mode based on the security level of the room, judged by the administration server; and
a printer that performs printing by the print mode selected by the print mode switcher.

According to a second aspect of the present invention, an image forming apparatus existing in a room equipped with a detection apparatus that detects a user who enters or exits the room, includes:
a print mode switcher that selects a print mode based on a security level of the room, judged based on a detection result drawn by the detection apparatus; and
a printer that performs printing by the print mode selected by the print mode switcher.

According to a third aspect of the present invention, an image forming method includes:
detecting a user who enters or exits a room where an image forming apparatus exists;
judging a security level of the room based on a drawn detection result;
selecting a print mode of the image forming apparatus, based on the judged security level of the room; and
making the image forming apparatus perform printing by the selected print mode.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1 is a block diagram schematically showing a configuration of an image forming system according to one embodiment of the present invention;

FIG. 2 is a block diagram showing a functional configuration of an administration server;

FIG. 3 is a block diagram showing a functional configuration of an image forming apparatus;

FIG. 4 is a table showing the card levels set in advance for users who enter or exit a room where the image forming apparatus exists;

FIG. 5 is a table showing a standard to judge a security level of the room in this embodiment;

FIG. 6 is a view to briefly explain operations performed in the image forming system when a security level of the room is judged as “high”;

FIG. 7 is a view to briefly explain operations performed in the image forming system when a security level of the room is judged as “low”;

FIG. 8 is a table showing a table to select a suitable print mode for the security level of a confidential document and the security level of the room;

FIG. 9 is a view to briefly explain other operations performed in the image forming apparatus when a security level of the room is judged as “low”;

FIG. 10 is a flowchart representing a procedure executed in the administration server;

FIG. 11 is a flowchart representing a procedure executed in the image forming apparatus; and

FIG. 12 is a flowchart representing another procedure executed in the image forming apparatus.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

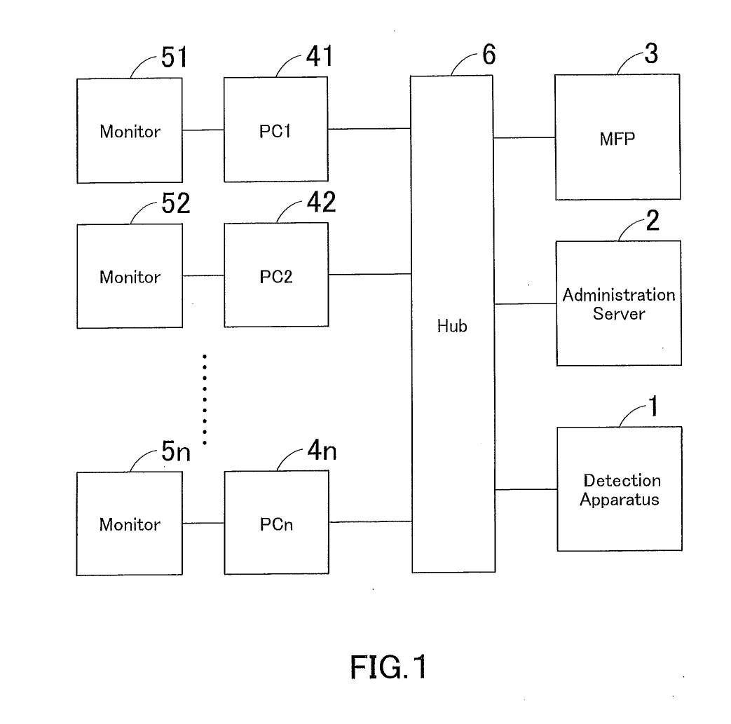

FIG. 1 is a block diagram schematically showing a configuration of an image forming system according to one embodiment of the present invention.

This image forming system includes a detection apparatus 1 that detects users who enter or exit a room, an administration server 2 that administers entries and exits, an image forming apparatus 3, and terminal apparatuses 41, 42, . . . and 4n that are a plurality of personal computers. The detection apparatus 1, the administration server 2, the image forming apparatus 3 and the terminal apparatuses 41, 42, . . . 4n are capable of communicating with each other via a hub 6. And one detection apparatus 1 is provided in one room, meanwhile at least one image forming apparatus 3 is provided in one room. The administration server 2 may be provided in the same room as the image forming apparatus 3, or may be provided in a different room. The terminal apparatuses 41, 42, . . . and 4n include monitors 51, 52, . . . and 5n that are display apparatuses, respectively.

In this embodiment, a MFP (Multi Function Peripheral) that is a multifunctional digital machine collectively having a plurality of functions, for example the copy function, the print function, the scan function, the facsimile function and other functions, is employed as the image forming apparatus 3. Hereinafter, an image forming apparatus will be sometimes referred to simply as “MFP”.

The detection apparatus 1 reads out identification information to identify a user, from his/her entry/exit card that is an ID card storing the identification information. Each user has his/her own entry/exit card, and puts his/her entry/exit card over the detection apparatus 1 when enters or exits a room. Then, the detection apparatus 1 reads out identification information of this user therefrom.

The administration server 2 is a personal computer for example, and judges a security level of a room based on identification information of a user who enters or exits the room, which is obtained by the detection apparatus 1. If there are a plurality of rooms each having the detection apparatus 1 and the image forming apparatus 3, the administration server 2 judges security levels of the respective rooms.

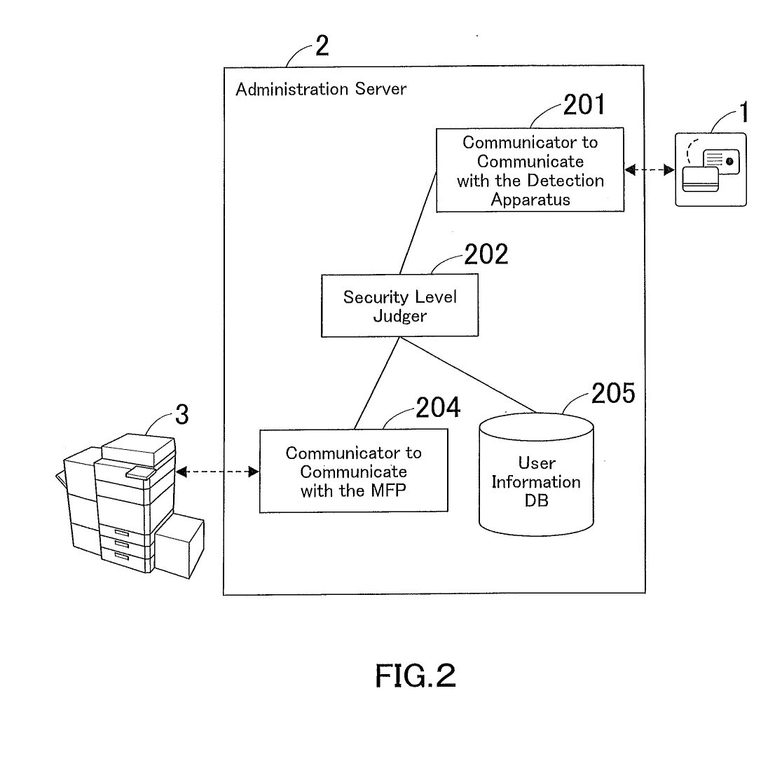

FIG. 2 is a block diagram showing a functional configuration of the administration server 2. This administration server 2 includes a communicator 201 to communicate with the detection apparatus 1, a security level judger 202, a communicator 204 to communicate with the MFP 3, and a user information database (referred to as “user information DB” in FIG. 2) 205.

The communicator 201 to communicate with the detection apparatus 1, receives identification information of a user who enters or exits a room, from the detection apparatus 1, and transmits the received identification information to the security level judger 202.

The security level judger 202 identifies a user who enters or exits a room, based on identification information of the user, received from the detection apparatus 1, and judges a security level of the room based on information of the identified user. Concretely, the security level judger 202 identifies a user who enters or exits a room by comparing the identification information received from the detection apparatus 1 to user information recorded in advance in the user information database 205, and judges a security level of the room based on a category of the identified user.

The user information database 205 carries user information about respective users and identification information recorded in their entry/exit cards, recorded in advance with connection.

The communicator 204 to communicate with the MFP 3 controls communication with the MFP 3.

The communicator 201 to communicate with the detection apparatus 1, the security level judger 202, the communicator 204 to communicate with the MFP 3, the user information database 205 and others described above are connected to a CPU, a ROM, a RAM, a memory (for example, a hard disk drive) and other portions not shown in Figures.

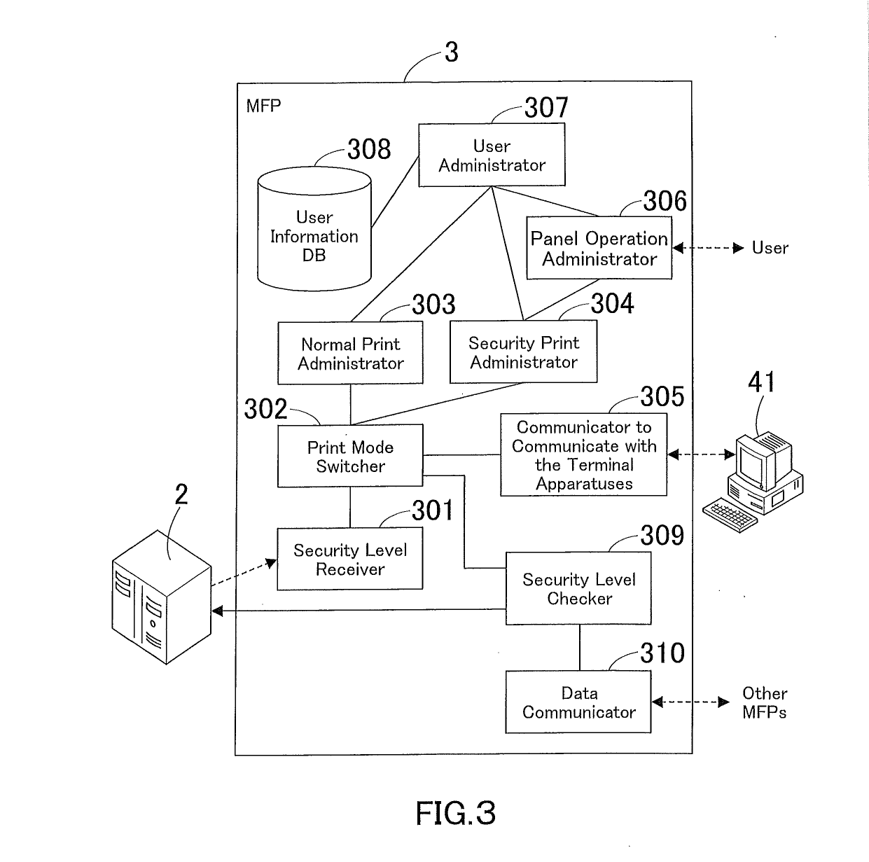

FIG. 3 is a block diagram showing a functional configuration of the MFP 3. This MFP 3 includes a security level receiver 301, a print mode switcher 302, a normal print administrator 303, a security print administrator 304, a communicator 305 to communicate with the terminal apparatuses, a panel operation administrator 306, a user administrator 307, a user information database 308, a security level checker 309 to check security levels of the other rooms, a data communicator 310, and etc.

The security level receiver 301 receives a current security level of a room where the MFP 3 exists, which is judged by the administration server 2.

The print mode switcher 302 switches between print modes for the security level of the room, received by the security level receiver 301.

In this embodiment, if the security level of the room is relatively high, the normal print mode that is the non-security print mode not ensuring security of printouts is selected. Meanwhile, if the security level of the room is relatively low, the security print mode ensuring security of printouts is selected.

The normal print administrator 303 performs normal printing when the normal print mode is selected by the print mode switcher 302.

The security print administrator 304 performs a security operation when the security print mode is selected.

Concretely, the security operation performed when the security print mode is selected may correspond to: suspension of printing a confidential document; discharging printouts onto a personal discharge tray of a user who instructed printing; or requiring for entry of a password when a user instructs printing or when printouts are discharged. When a user instructs printing by operating the terminal apparatus 41, 41, . . . or 4n, a normal print mode button may be grayed out in a print setting screen opened by a print driver, so as to let the user select only a security print mode button. Alternatively, when a user instructs printing, a message that warns as “printing is not available now” may be displayed, and if the user still instructs printing again, a print job may be spooled and the stand-by mode may be selected. In such a case, printing is started when the security level of the room changes to “high”.

If the security level of the room changes during printing, the current print mode is also changed, and a notice telling that the security level has changed and/or the print mode has been changed, may be transmitted to a user who instructed printing or a user who was specified to receive a confidential printout for example, by e-mail or via the terminal apparatus 41, 42, . . . or 4n.

The communicator 305 to communicate with the terminal apparatuses, receives a print job from the terminal apparatuses 41, 42, . . . and 4n. Depending on the print mode, the normal print administrator 303 performs normal printing or the security print administrator 304 performs security printing, about a received print job. Furthermore, as described above, if the security level changes during printing, the communicator 305 to communicate with the terminal apparatuses transmits a notice telling that the security level has changed and/or the current print mode has been switched to another one, to a user who instructed printing or a user who was specified to receive a confidential printout for example.

The panel operation administrator 306 administrates user operations performed by operating an operation panel not shown in Figures. For example, when a user performs an operation to cancel the security print mode, the panel operation administrator 306 cancels the security print mode by making the security print administrator 304 not to perform security printing. Furthermore, the operation controller 306 transmits to the user administrator 307, user information entered via the operation panel, meanwhile receives user information from the user administrator 307 and displays an appropriate screen on a display of the operation panel.

The user administrator 307 administers user information recorded in the user information database 308 and identifies a user who instructed printing or a user who was specified to receive printouts.

If the administration server 2 judges that the security level of the room changes from high to low, the security level checker 309 to check security levels of other rooms identifies any other room which security level is high, by communicating to the administration server 2.

The data communicator 310 transfers a unexecuted print job to an image forming apparatus existing in the room which security level is high, identified by the security level checker 309.

The security level receiver 301, the print mode switcher 302, the normal print administrator 303, the security print administrator 304, the communicator 305 to communicate with terminal apparatuses, the panel operation administrator 306, the user administrator 307, the user information database 308, the security level checker 309, the data communicator 310 and etc. are connected to a CPU, a ROM, a RAM, a memory (hard disk drive), a scanner and etc. not shown in Figures.

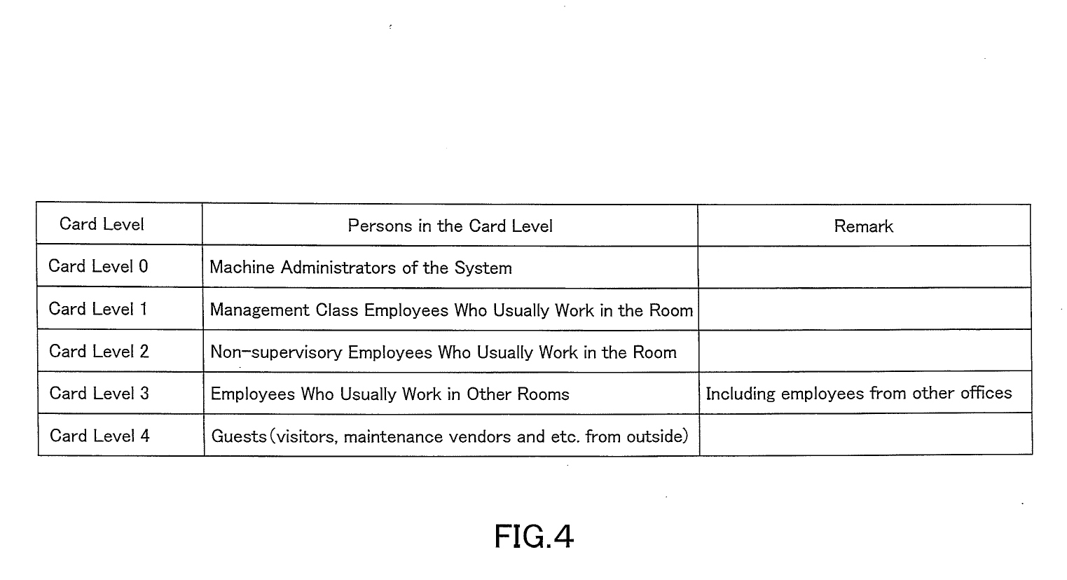

FIG. 4 is a table showing connections among positions of the persons who may enter or leave a room, their card levels and etc., recorded in advance. In this example, the card level 0 is given to machine administrators of the detection apparatus 1 and the administration server 2, the card level 1 is given to management level employees who usually work in the room, the card level 2 is given to non-supervisory employees who usually work in the room, the card level 3 is given to employees who usually work in other rooms, and the card level 4 is given to guest users, for example visitors, maintenance engineers and others from outside, respectively.

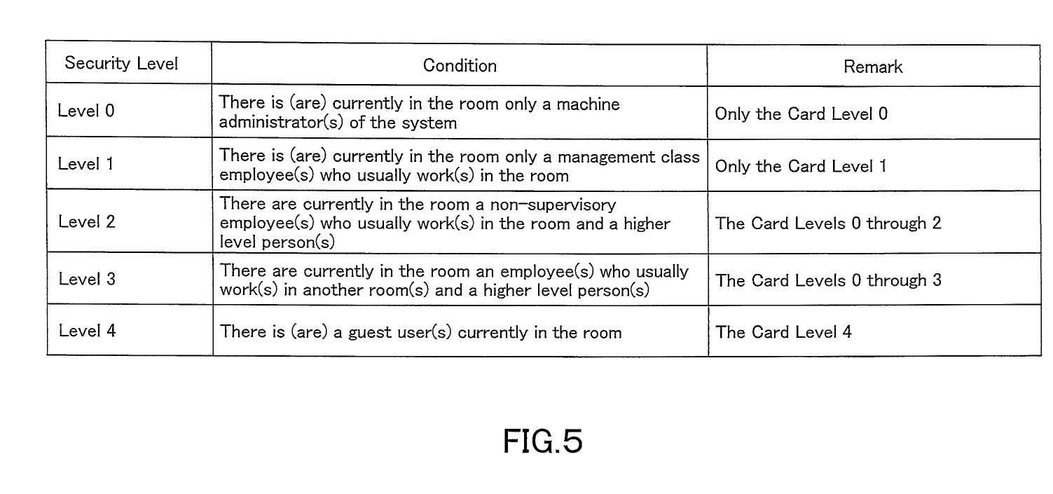

FIG. 5 is a table showing a standard to judge a security level of a room based on a card level that is given to a user who enters or exits the room, which is used in this embodiment.

When there is (are) currently in the room, only a machine administrator(s) of this image forming system (the card level 0), a security level of the room is judged as 0. When there is (are) currently in the room, only a management level employee(s) who usually work(s) in the room (the card level 1), a security level of the room is judged as 1. When there are currently in the room, persons in the card levels 0 through 2, in other words, a non-supervisory employee(s) who usually work(s) in the room (the card level 2) and an higher level person(s), a security level of the room is judged as 2. When there are currently in the room, persons in the card levels 0 through 3, in other words, an employee(s) who usually work(s) in another room(s) (the card level 3) and an higher level person(s), a security level of the room is judged as 3. When there is (are) a guest user(s) (the card level 4) currently in the room, a security level of the room is judged as 4.

The security level 0 represents the highest security level. The security level 4 represents the lowest security level. In this embodiment, the administration server 2 judges the security levels 0 through 3 as “high”, the security level 4 as “low”.

Standards to judge a card level and a security level are not limited to the table 4 and the table 5, respectively, and those may be arranged arbitrarily. More security levels may exist between the security levels “high” and “low”, and also more print modes suitable for these security levels may exist.

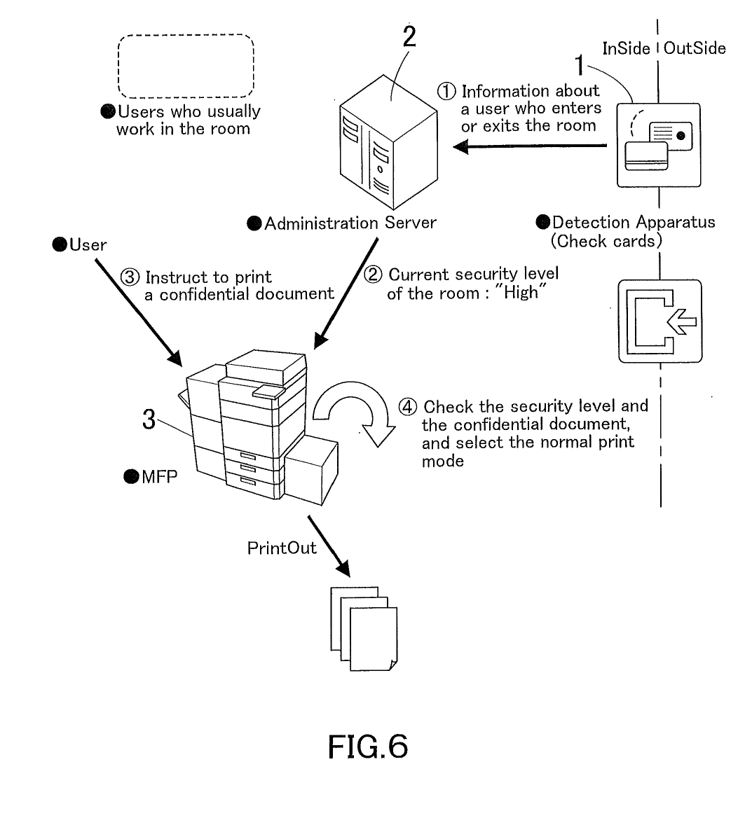

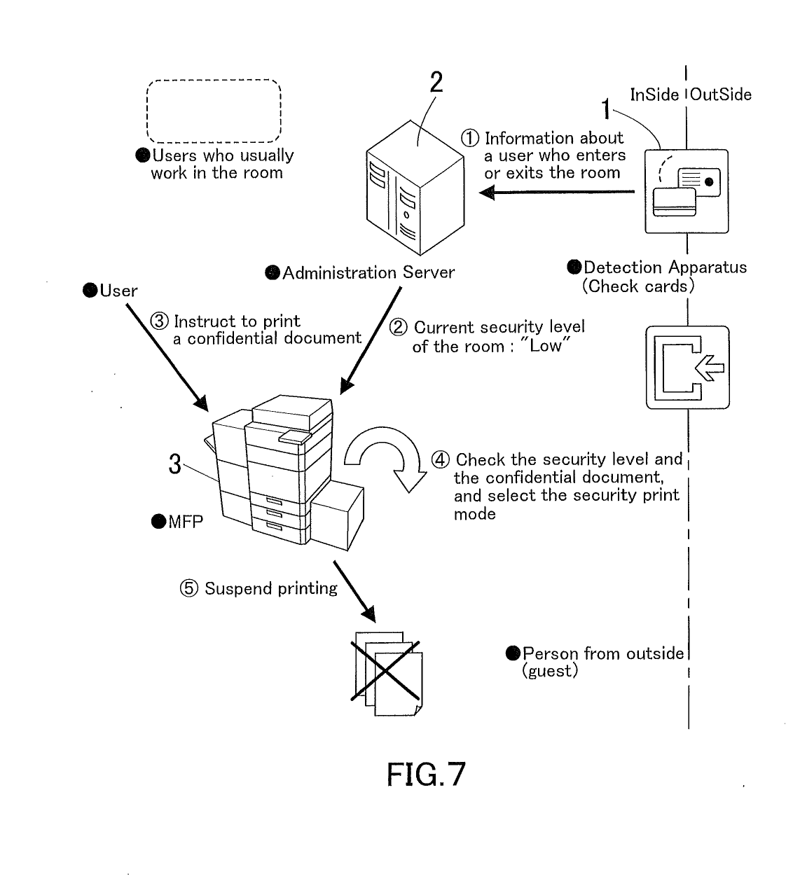

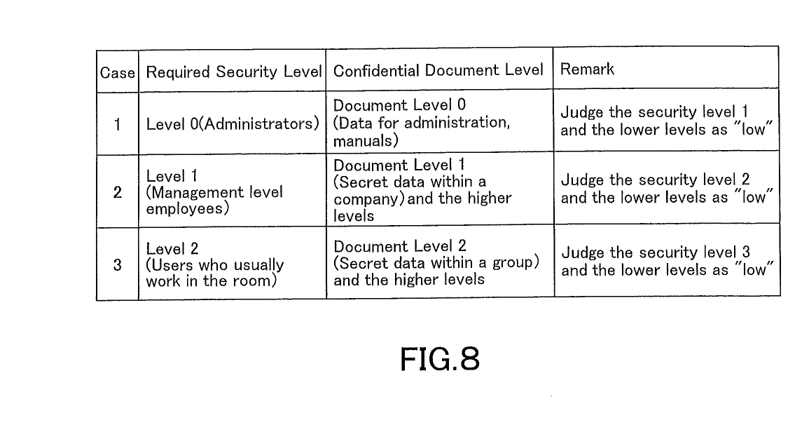

Hereinafter, the operations performed in the image forming system of FIG. 1 will be briefly explained with reference to FIG. 6, FIG. 7 and FIG. 8.

FIG. 6 shows operations performed when a security level of a room where the MFP 3 exists, is judged as “high”.

A user makes the detection apparatus 1 read his/her entry/exit card every time he/she enters or exits the room. This user's information read out from the entry/exit card by the detection apparatus 1 is transmitted to the administration server 2 (Circled Number 1 in FIG. 6), and the administration server 2 judges a current security level of the room. If there are currently in the room, only non-supervisory employees who usually work in the room, the administration server 2 judges a security level of the room as “high”, then the judgment result is transmitted to the MFP 3 (Circled Number 2 in FIG. 6).

Subsequently, another user gives to the MFP 3 an instruction to print a confidential document (Circled Number 3 in FIG. 6). Here, this user may have the MFP 3 print (copy) a document that carries information indicating that it is a confidential document, which is given in advance such as a ground pattern, so that the MFP 3 could recognize that this is an instruction to print a confidential document, by detecting that information therefrom. Alternatively, this user may select a print job to print a confidential document using a printer driver installed on the terminal apparatus 41, 42 . . . or 4n and transmit the print job to the MFP 3.

Receiving the security level from the administration server 2, the MFP 3 checks the security level and the confidential document to be printed according to the user instruction (makes sure that it really is a confidential document). Since the security level of the room is “high”, the MFP 3 selects the normal print mode for printing (Circled Number 4 in FIG. 6), and performs normal printing. The MFP 3 may switch the current print mode to a suitable print mode for the security level even if it is not a confidential document, and may always select the normal print mode for printing regardless of the security level.

FIG. 7 shows operations performed when a security level of a room where the MFP 3 exists, is judged as “low”.

A user makes the detection apparatus 1 read his/her entry/exit card every time he/she enters or exits the room. This user's information read out from the entry/exit card by the detection apparatus 1 is transmitted to the administration server 2 (Circled Number 1 in FIG. 7), and the administration server 2 judges a current security level of the room. If there are currently in the room, non-supervisory employees who usually work in the room and a guest user, the administration server 2 judges a security level of the room as “low”, then the judgment result is transmitted to the MFP 3 (Circled Number 2 in FIG. 7).

Subsequently, another user gives to the MFP 3 an instruction to print a confidential document (Circled Number 3 in FIG. 7).

Receiving the security level from the administration server 2, the MFP 3 checks the security level and the confidential document to be printed according to the user instruction (makes sure that it really is a confidential document). Since the security level of the room is “low”, the MFP 3 selects the security print mode for printing (Circled Number 4 in FIG. 7). In this example, suspension of printing is employed as the security operation performed when the security print mode is selected, thus the MFP 3 suspends printing the confidential document (Circled Number 5 in FIG. 7).

As described above, the MFP 3 selects a suitable print mode for a security level judged by the administration server 2, and performs printing by the selected print mode. That is, the MFP 3 automatically selects a suitable print mode for a person(s) who is (are) currently in the room. And thus, even when a person who is considered to be unfavorable for security reasons is currently in the room, the MFP 3 ensures security of printouts. Furthermore, when such a person is not in the room, the MFP 3 can print a confidential document without consideration of security of printouts, ensuring security of printouts by an easy method, without limiting other users' entering or leaving the room.

If the security level of the room changes from “high” to “low” while normal printing is performed by the normal print mode, the normal print mode is switched to the security print mode, and thus the printing is suspended. In this case, a notice telling that the security level of the room has changed from “high” to “low” and normal printing has been switched to security printing, is transmitted to a user who instructed printing or a user who was specified to receive a confidential printout for example, by e-mail or via the terminal apparatus 41, 42 . . . or 4n. Thus, the recipient user knows that the security level of the room has changed.

If the security level of the room changes from “low” to “high” during suspension of the printing, the printing is resumed, or alternatively, the security print mode is canceled and switched to the normal print mode. And also in this case, a notice telling that the security level of the room has changed from “low” to “high” and/or the print mode has been changed, is transmitted to a user who instructed printing or a user who was specified to receive a confidential printout for example.

In this example, another configuration may be employed, wherein a confidential level is given to a confidential document, and a suitable print mode for the confidential level of the confidential document and the security level of the room, is selected.

For example, as shown in FIG. 8, when a document is administrative data or an administrative manual, the document level 0 is given to the document. When a document is secret data within a company, the document level 1 is given to the document. When a document is secret data within a group, the document level 2 is given to the document. More specifically, when there is only a user in the card level 0 currently in the room and this user is trying to print a document of the document level 0, then the security level 1 and the lower security levels of the room may be judged as “low”.

When there is only a user in the card level 1 currently in the room and this user is trying to print a document of the document level 1 or a higher document level, then the security level 2 and the lower security levels of the room may be judged as “low”.

When there is only a user in the card level 2 currently in the room and he/she is trying to print a document of the document level 2 or a higher document level, then the security level 3 and the lower security levels of the room may be judged as “low”.

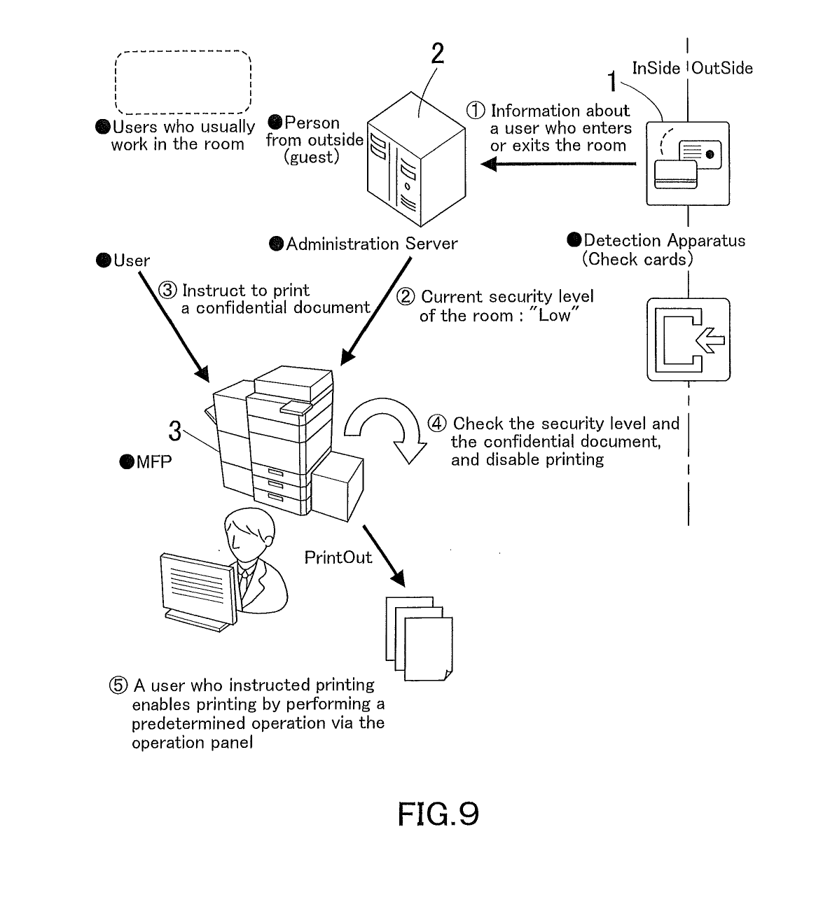

FIG. 9 shows operations performed when a security level of a room where the MFP 3 exists, is judged as “low”. In this example, a user resumes printing by operating the operation panel of the MFP 3 while the printing is suspended due to the security print mode.

A user makes the detection apparatus 1 read his/her entry/exit card every time he/she enters or exits the room. This user's information read out from the entry/exit card by the detection apparatus 1 is transmitted to the administration server 2 (Circled Number 1 in FIG. 9), and the administration server 2 judges a current security level of the room. If there are currently in the room, a non-supervisory employee who usually works in the room and a guest user, the administration server 2 judges a security level of the room as low“, then the judgment result is transmitted to the MFP 3 (Circled Number 2 in FIG. 9).

Subsequently, another user gives to the MFP 3 an instruction to print a confidential document (Circled Number 3 in FIG. 9).

Receiving the security level from the administration server 3, the MFP 3 checks the security level and the confidential document to be printed according to the user instruction (makes sure that it really is a confidential document), and selects the security print mode for printing. In this example, since suspension of printing is employed as the security operation performed when the security print mode is selected, the MFP 3 suspends printing the confidential document (Circled Number 4 in FIG. 9).

After suspending the printing, the user who instructed printing cancels the security print mode via the operation panel of the MFP 3, and thereby the MFP 3 resumes the printing (Circled Number 5 in FIG. 9).

The user who instructed printing may cancel the security print mode by entering a password for resumption of printing, for example. That is, the user who instructed printing enters a password to cancel the security print mode, and thereby the MFP 3 resumes the printing, recognizing that the user is now by the side thereof. The password for resumption of printing may be set in advance, or alternatively may be a one-time password that is created when the security print mode is selected, and transmitted to the user's terminal apparatus 41, 42 . . . or 4n, to be later compared to a password entered via the operation panel of the MFP 3.

As described above, in this embodiment, a user can cancel the security print mode selected by the print mode switcher 302, which would prove that it is a convenient image forming system that efficiently reflects user's intention.

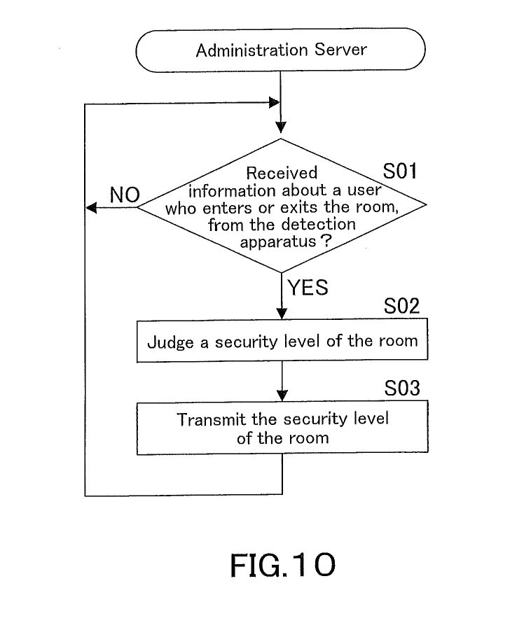

FIG. 10 is a flowchart representing a procedure executed in the administration server 2.

In Step S01, the administration server 2 judges whether or not information about a user who enters or exits the room is received from the security detection server 1. If it is not received (NO in Step S01), the routine waits until it is received. If it is received (YES in Step S01), a security level of the room is judged in Step S02, and the judged security level is transmitted to the MFP 3 in Step S03.

If there are a plurality of rooms each having the MFP 3 and the administration server 2 administers security levels of the rooms individually, Steps S01 through S03 are performed about the respective rooms.

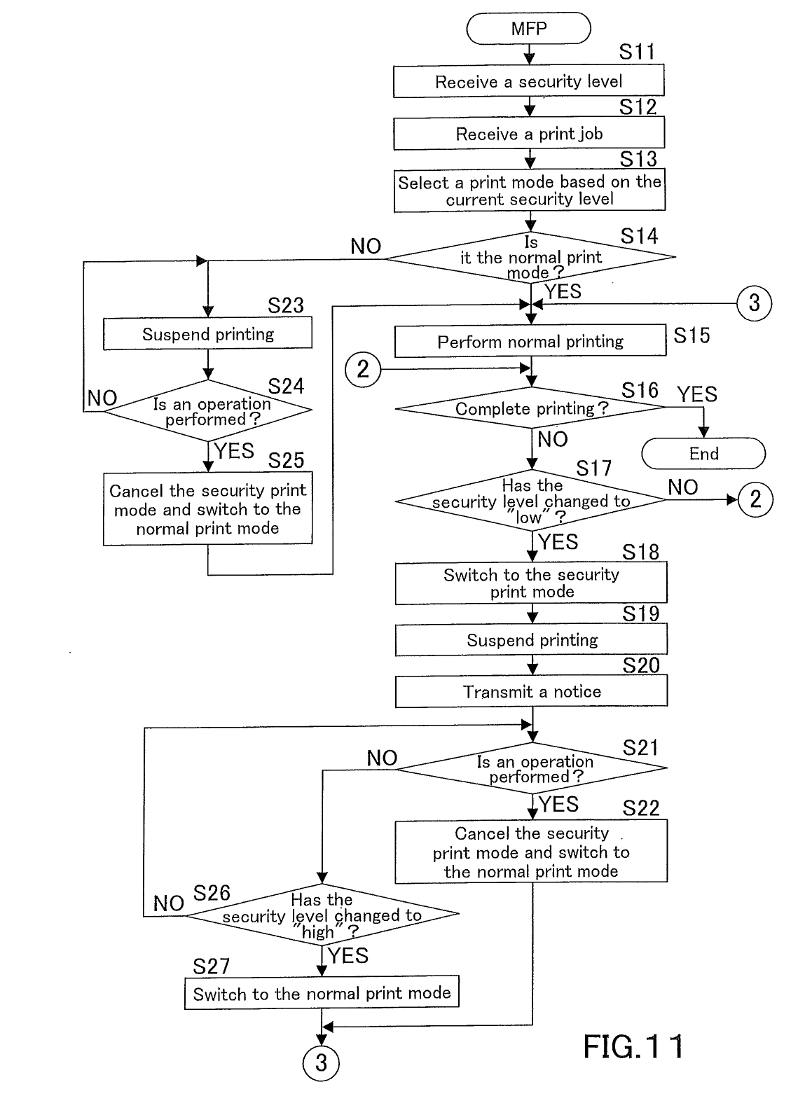

FIG. 11 is a flowchart representing a procedure executed in the MFP 3.

In Step S11, the MFP 3 receives the security level of the room from the administration server 2. This receiving process is performed on a steady basis regardless of progress of the routine.

In Step S12, a print job to print a confidential document is received. And in Step S13, a suitable print mode for the current security level of the room is selected.

In Step S14, it is judged whether or not the selected one is the normal print mode. If it is the normal print mode (YES in Step S14), normal printing is performed in Step S15.

If it is not the normal print mode (NO in Step S14), printing is suspended in Step S23, since it should be the security print mode. And it is judged in Step S24, whether or not a print mode cancellation operation is performed by user. If a print mode cancellation operation is not performed (NO in Step S24), the routine goes back to Step S23, wherein printing is continuously suspended. If a print mode cancellation operation is performed (YES in Step S24), the security print mode is canceled and switched to the normal print mode in Step S25, and normal printing is performed in Step S15. Then the routine proceeds to Step S16.

In Step S16, it is judged whether or not the printing is completed. If the printing is completed (YES in Step S16), the routine terminates. If the printing is not completed (NO in Step S16), the routine proceeds to Step S17, wherein it is judged whether or not the security level “low” has been received from the administration server 2, in other words, the security level of the room has changed to “low”.

In Step S17, if the security level of the room has not changed to “low” (NO in Step S17), the routine goes back to Step S15, wherein the normal printing is continuously performed. If the security level of the room has changed to “low” (YES in Step S17), the normal print mode is switched to the security print mode in Step S18, and the printing is suspended in Step S19. Subsequently, a notice telling that the printing is suspended since the security level of the room has changed, for example, is transmitted to either a user who instructed printing or a user who was specified to receive a printout, or both of them.

And in Step S21, it is judged whether or not a print mode cancellation operation is performed by user. If a print mode cancellation operation is not performed (NO in Step S21), then it is judged in Step S26, whether or not the security level of the room has changed to “high”. If it has not changed (NO in Step S26), the routine goes back to Step S21, to wait until a print mode cancellation operation is performed. If it has changed (YES in Step S26), the security print mode is switched to the normal print mode in Step S27. After that, the routine goes back to Step S15, wherein normal printing is performed.

In Step S21, if a print mode cancellation operation is performed (YES in Step S21), the security print mode is canceled and switched to the normal print mode in Step S22. After that, the routine goes back to Step S15, wherein normal printing is performed.

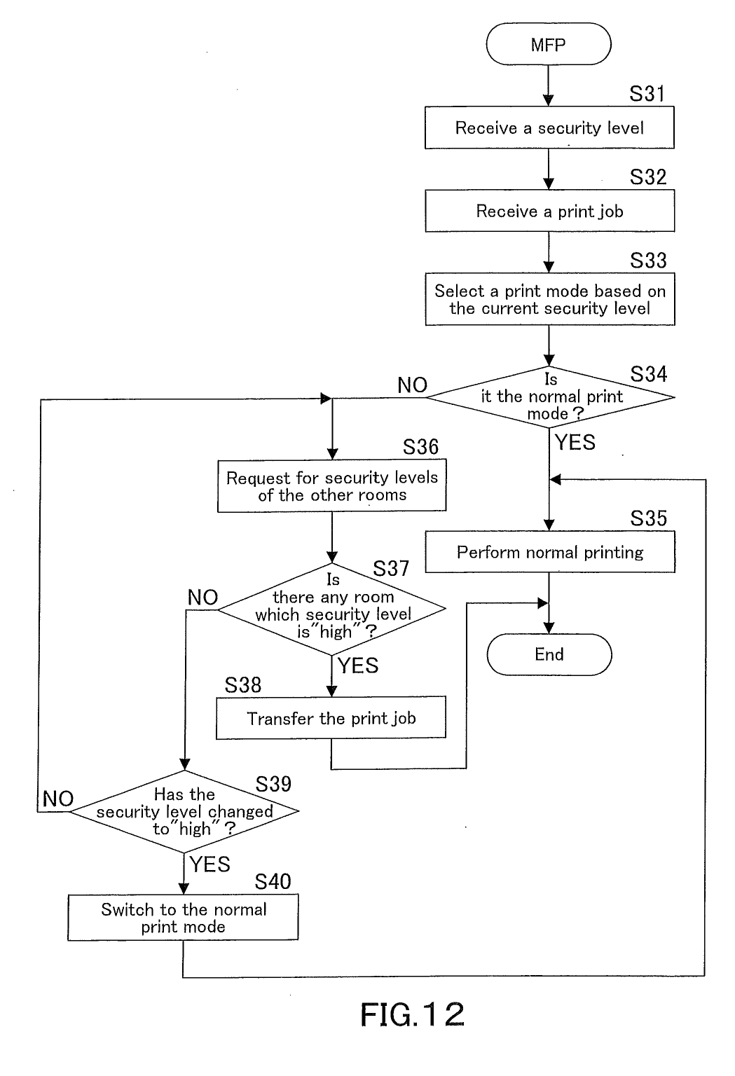

FIG. 12 relates to another embodiment of the present invention, and is a flowchart representing a procedure executed in the MFP 3.

The MFP 3 receives the security level of the room from the administration server 2, in Step S31. This receiving process is performed on a steady basis.

In Step S32, a print job to print a confidential document is received. And in Step S33, a print mode is selected based on the current security level of the room.

In Step S34, it is judged whether or not it is the normal print mode. If it is the normal print mode (YES in Step S34), normal printing is performed in Step S35, then the routine terminates.

If it is not the normal print mode (NO in Step S34), the security levels of the other rooms are obtained from the administration server 2, in Step S36. And it is judged in Step S37, whether or not there is any room which security level is “high”, based on the obtained security levels. If there is such a room (YES in Step S37), the print job is transferred to the MFP 3 existing in the room which security level is “high”, in Step S38.

In Step S37, if there is not any room which security level is “high” (NO in Step S37), then it is judged in Step S39, whether or not the security level of the room has changed to “high”. If it has not changed (NO in Step S39), the routine goes back to Step S36.

If it has changed (YES in Step S39), the security print mode is switched to the normal print mode in Step S40. After that, the routine goes back to Step S35, wherein normal printing is performed.

As described above, in this embodiment, if the security level of the room has changed from “high” to “low”, an unexecuted print job is transferred to the MFP 3 existing in another room which security level is “high”, and this MFP 3 executes the print job. This would eliminate the inconvenience that printing is unfavorably performed in a room which security level became to “low”, and ensure security of printouts properly.

In these embodiments described above, the administration server 2 and the MFP 3 are independently provided. Instead, the functions of the administration server 2 may be installed on the MFP 3. In this case, the MFP 3 receives information about a user who enters or exits a room where the MFP 3 exists, read out by the detection apparatus 1, and also judges a security level of the room.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g. of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to”. In this disclosure and during the prosecution of this application, means-plus-function or step-plus-function limitations will only be employed where for a specific claim limitation all of the following conditions are present In that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example”, and “NB” which means “note well”.

What is claimed is:

1. An image forming system comprising:
an image forming apparatus;
a detection apparatus that detects a user who enters or exits a room where the image forming apparatus exists; and
an administration server that judges a security level of the room based on a detection result drawn by the detection apparatus,
and wherein:
the image forming apparatus comprises:
a print mode switcher that selects a print mode based on the security level of the room, judged by the administration server; and
a printer that performs printing by the print mode selected by the print mode switcher.

2. The image forming system recited in claim 1, wherein:
if the security level of the room, judged by the administration server, is relatively high, the print mode switcher of the image forming apparatus selects the non-security print mode not ensuring security of printouts, meanwhile if the security level of the room is relatively low, the print mode switcher selects the security print mode ensuring security of printouts.

3. The image forming system recited in claim 1, further comprising:
a notifier that transmits to a user who instructed printing or a user who was specified to receive a printout, a notice telling that the security level of the room, judged by the administration server, has changed and/or the current print mode has been switched to another one, if the security level changes during printing.

4. The image forming system recited in claim 2, wherein:
the image forming apparatus further comprises a terminator that terminates the security print mode selected by the print mode switcher, according to a user operation.

5. The image forming system recited in claim 1, further comprising:
a transfer portion that transfers a unexecuted print job to an image forming apparatus existing in another room which security level is relatively high, if the security level of the room, judged by the administration server, changes from high to low.

6. An image forming apparatus existing in a room equipped with a detection apparatus that detects a user who enters or exits the room, comprising:
a print mode switcher that selects a print mode based on a security level of the room, judged based on a detection result drawn by the detection apparatus; and
a printer that performs printing by the print mode selected by the print mode switcher.

7. The image forming apparatus recited in claim 6, wherein:
if the security level of the room is relatively high, the print mode switcher selects the non-security print mode not ensuring security of printouts, meanwhile if the security level of the room is relatively low, the print mode switcher selects the security print mode ensuring security of printouts.

8. The image forming apparatus recited in claim 6, further comprising:
a notifier that transmits to a user who instructed printing or a user who was specified to receive a printout, a notice telling that the judged security level of the room has changed and/or the current print mode has been switched to another one, if the security level of the room changes during printing.

9. The image forming apparatus recited in claim 7, further comprising:
a terminator that terminates the security print mode selected by the print mode switcher, according to a user operation.

10. The image forming apparatus recited in claim 6, further comprising:
a transfer portion that transfers an unexecuted print job to an image forming apparatus existing in another room which security level is relatively high, if the security level of the room changes from high to low.

11. The image forming apparatus recited in claim 6, further comprising:
a judger that judges a security level of printouts.

12. An image forming method implemented by an image forming system, comprising:
detecting a user who enters or exits a room where an image forming apparatus exists;
judging a security level of the room based on a drawn detection result;
selecting a print mode of the image forming apparatus, based on the judged security level of the room; and
making the image forming apparatus perform printing by the selected print mode.

13. The image forming method recited in claim 12, wherein:
if the judged security level of the room is relatively high, the non-security print mode not ensuring security of printouts is selected, meanwhile if the judged security level of the room is relatively how, the security print mode ensuring security of printouts is selected.

14. The image forming method recited in claim 12, further comprising:
transmitting to a user who instructed printing or a user who was specified to receive a printout, a notice telling that the judged security level of the room has changed and/or the current print mode has been switched to another one, if the security level of the room changes during printing.

15. The image forming method recited in claim 13, further comprising:
terminating the selected security print mode according to a user operation.

16. The image forming method recited in claim 12, further comprising:
transferring a unexecuted print job to an image forming apparatus existing in another room which security level is relatively high, if the security level of the room changes from high to low.
